(19) United States
(12) Patent Application Publication
(10) Pub. No.: US 2020/0044520 A1
(43) Pub. Date: Feb. 6, 2020

(54) ROTOR OF AN ELECTRIC MACHINE, IN PARTICULAR OF A CLAW POLE MACHINE

(71) Applicant: SEG Automotive Germany GmbH, Stuttgart (DE)

(72) Inventors: Benjamin KLEIN, Bietigheim-Bissingen (DE); Bernd SCHROEDER, Renningen (DE); Andreas HOCH, Rutesheim (DE)

(21) Appl. No.: 16/530,085

(22) Filed: Aug. 2, 2019

(30) Foreign Application Priority Data
Aug. 2, 2018 (DE) 102018118759.9

(51) Int. Cl. H02K 13/02; H02K 3/52; H01R 39/14; H02K 13/00

(52) U.S. Cl. CPC H02K 13/02; H02K 13/003; H01R 39/14; H02K 3/528

(57) ABSTRACT

A rotor of an electric machine, in particular of a claw pole machine, has a slip ring arrangement with two slip rings which are arranged on the rotor shaft, the slip rings being placed onto an insulating sleeve which is of electrically insulating configuration and is seated directly on the rotor shaft, the insulating sleeve (59) having a thermal conductivity of at least 2 W/mK.

### CROSS-REFERENCE TO RELATED APPLICATIONS

This application claims the benefit of priority to German Patent Application No. 102018118759.9 filed Aug. 2, 2018, each of which is incorporated herein by reference in its entirety.

### SUMMARY

The invention relates to a rotor of an electric machine, in particular of a claw pole machine, having a slip ring arrangement which comprises two slip rings which are arranged on the rotor shaft of the rotor and are connected via in each case one busbar to the winding wire of a rotor winding.

### PRIOR ART

DE 38 38 436 A1 has disclosed a claw pole machine, the rotor of which has a slip ring arrangement, via which a field current can be transmitted to a field winding of the rotor. The slip ring arrangement comprises two axially adjacent slip rings which are arranged on the rotor shaft and with which brushes are in sliding contact. The slip rings are connected via in each case one busbar to the ends of the field winding.

### DISCLOSURE OF THE INVENTION

The rotor according to the invention can be used in electric machines, such as claw pole machines, which are used, for example, in vehicles in boost/recuperation systems. The rotor of the electric machine has a slip ring arrangement, by way of which an electric field current is transmitted to a field or rotor winding in the rotor. The slip ring arrangement comprises two slip rings which are arranged on the rotor shaft of the rotor and are connected in each case to a winding wire end of the rotor winding. The current transmission from the slip rings to the rotor winding takes place with the aid of busbars. Current-conducting or current-guiding brushes which are mounted in the housing of the electric machine are in contact with the slip rings.

The slip ring arrangement comprises an insulating sleeve, onto which the two slip rings are placed. The slip rings are situated so as to lie axially next to one another on the insulating sleeve which is of electrically insulating configuration, in order to prevent a current flow between the slip rings and/or between the slip rings and the rotor shaft. The insulating sleeve is seated directly on the rotor shaft, the insulating sleeve having a thermal conductivity of at least 2 W/mK.

This embodiment has the advantage that the waste heat which is produced in the region of the slip ring arrangement can be dissipated efficiently via the rotor shaft. The waste heat is transmitted from the slip rings via the insulating sleeve to the rotor shaft and, in the case of an embodiment of the electric machine as a claw pole machine, can be discharged via the claw poles and fans which are possibly present in the electric machine. On account of the direct contact between the insulating sleeve and the rotor shaft, the thermal transfer from the slip rings to the insulating sleeve and further to the rotor shaft is improved.

The insulating sleeve consists of a material with a high thermal conductivity, in order to improve and to assist the thermal transport from the slip rings to the rotor shaft.

In contrast to embodiments from the prior art, no plastic component lies between the slip rings and the rotor shaft, but rather merely the insulating sleeve which is produced from a thermally conducting material, in order to ensure the desired efficient heat dissipation. The insulating sleeve acts merely in an electrically insulating manner, but at the same time in a thermally conducting manner, and has, in particular, a higher thermal conductivity than customary plastic material. The insulating sleeve preferably has a thermal conductivity of at least 2.5 W/mK or at least 3 W/mK.

In accordance with one particularly advantageous embodiment, the insulating sleeve material of the insulating sleeve comprises a polymer, preferably of at least 10% by weight or of at least 25% by weight or of at least 50% by weight or of at least 75% by weight or of at least 90% by weight or of 100%. In particular, the insulating sleeve material is configured in the form of what is known as a compound (material mixture of polymer and a filler), as described, for example, in EP0875531A2, EP0794227A2 and EP0499585A1.

It can possibly be advantageous to produce insulating sleeves from a material which even has a significantly higher thermal conductivity, possibly a thermal conductivity which is better than that of steel. For example, the insulating sleeve material has a ceramic, in particular aluminum nitride, preferably of at least 10% by weight or of at least 25% by weight or of at least 50% by weight or of at least 75% by weight or of at least 90% by weight or of 100%, and a thermal conductivity of at least 170 W/mK, preferably at least 200 W/mK. In particular, the insulating sleeve material is configured in the form of a ceramic fiber composite material (ceramic matrix composite—CMC).

Moreover, it is advantageous that the rotor shaft can be provided with a greater diameter in that shaft section which receives the slip ring arrangement on account of the omission of a plastic component which, in the case of embodiments in the prior art, receives the slip rings. The insulating sleeve can be of comparatively thin-walled configuration, with the result that the shaft diameter can be increased with an unchanged radial space requirement. This firstly improves the stability, and secondly there is a greater contact area between the plastic sleeve and the rotor shaft on account of the greater shaft diameter, as a result of which the heat dissipation is improved further.

The busbars are connected to in each case one winding wire end of the rotor winding. It can be advantageous to arrange a contact tab between the busbars and the slip rings, which contact tab is connected at one end to the busbar and at the other end to one of the slip rings. The slip rings lie axially (in relation to the longitudinal axis of the rotor shaft) behind one another, it being possible for the busbar for the slip ring which lies further away axially from the rotor winding to be guided through the slip ring which lies in front. For this purpose, a longitudinal groove is advantageously made in the rotor shaft, in which longitudinal groove the contact tab is guided.

In accordance with a further advantageous embodiment, an axially running slot is made in the wall of the insulating sleeve, into which slot one of the contact tabs protrudes. The slot in the insulating sleeve makes it possible that the two slip rings are seated on the insulating sleeve and the electric contact of the slip rings takes place within the slip ring diameter. In the embodiment with contact tabs, in particular, that contact tab which is connected to the slip ring which lies further away from the rotor winding can be guided through the slot to contact said slip ring. The slot is preferably of axially shorter configuration than the insulating sleeve and extends as far as an axial end side of the insulating sleeve, the slot lying axially at a spacing from the opposite end side of the insulating sleeve.

In accordance with a further advantageous embodiment, the insulating sleeve is configured with a comparatively low wall thickness of at most 1 mm, it possibly also being possible for a wall thickness of at most 0.5 mm to be sufficient. Said low wall thickness of the insulating sleeve allows rotor shafts with greater diameters in the region of the slip ring arrangement to be used with unchanged external dimensions.

It can possibly be advantageous to configure the wall thickness of the insulating sleeve to be higher in the case of very high thermal conductivities, for example to provide a wall thickness for the insulating sleeve in the order of magnitude of from 1.5 to 2.5 mm, preferably approximately 2 mm.

In accordance with a further advantageous embodiment, the insulating sleeve material has a high thermal load-bearing capability which is, in particular, higher than the thermal load-bearing capability of a plastic overmolding of the slip ring arrangement, as a result of which melting or thermally induced softening of the insulating sleeve in the case of high thermal loading is prevented.

In accordance with a further advantageous embodiment, the rotor shaft has at least one longitudinal groove which extends in the axial longitudinal direction, possibly two longitudinal grooves which are arranged distributed over the circumference of the rotor shaft and serve to receive an electric contact of the slip rings. A plastic material can be introduced into the longitudinal grooves, with which plastic material the electric contact is overmolded, in order to prevent a short circuit between the electric contact and the rotor shaft. In the case of two longitudinal grooves, they are situated, for example, offset by 180° on the rotor shaft and, in the embodiment of the electric contact as a contact tab, can receive the contact tabs for the slip rings.

### BRIEF DESCRIPTION OF THE DRAWINGS

Further advantages and expedient embodiments can be gathered from the further claims, the description of the figures and the drawings, in which:

FIG. 1 shows a perspective view of an electric machine which is used, for example, as a boost/recuperation machine in a motor vehicle,

FIG. 2 shows a section longitudinally through the machine in accordance with FIG. 1 in the region of a slip ring arrangement,

FIG. 3 shows the slip ring arrangement in section in an individual illustration,

FIG. 4 shows a perspective view of the slip rings of the slip ring arrangement including the electric contact and a partially slotted insulating sleeve,

FIG. 5 shows the slip rings with a mounted insulating sleeve,

FIG. 6 shows the slip ring arrangement including a plastic overmolding, and

FIG. 7 shows a rotor shaft which is configured for receiving the slip ring arrangement.

In the figures, identical components are provided with identical designations.

### DETAILED DESCRIPTION

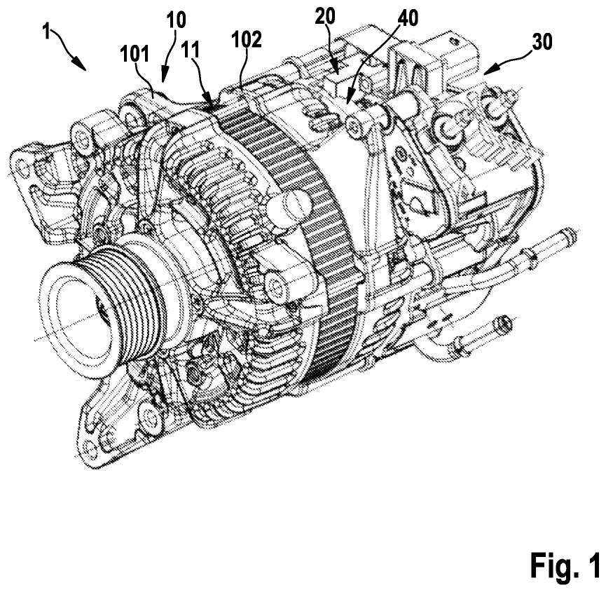

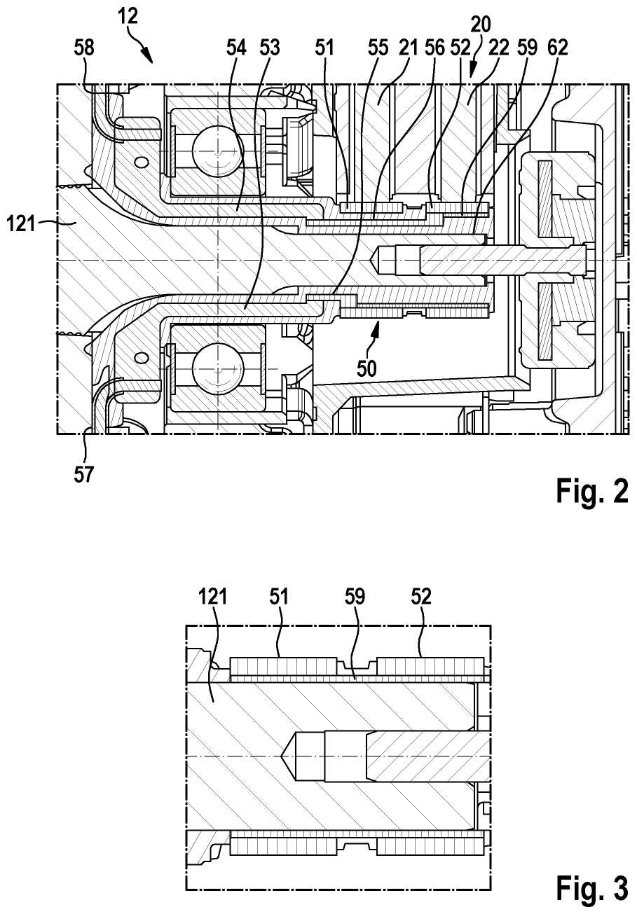

The electric machine 1 which is shown in FIG. 1 and in details in FIG. 2 can be used, for example, as a boost/recuperation machine in a motor vehicle and is configured as a claw pole machine. The electric machine 1 has a machine part 10 which contains the electric motor or generator, and comprises a stator 11 and an internal rotor 12 (FIG. 2). Furthermore, a brush holder 20 for the transmission of current to a rotor winding of the electric motor and power electronics 30 on the end side of the electric machine 1 belong to the electric machine 1. A connector plate 40 which connects the phases of the stator 11 to the power electronics 30 is situated between the machine part 10 and the power electronics 30. Moreover, the connector plate 40 serves to receive the brush holder 20.

The stator 11 of the machine part 10 is received between bearing plates 101 and 102 which form a housing. The stator 11 comprises a laminated core and a stator winding which is received in the laminated core. The bearing plates 101 and 102 additionally receive ball bearings, in which the rotor 12 with the rotor shaft 121 is mounted rotatably.

The transmission of current to the rotor winding of the rotor 12 takes place via a slip ring arrangement 50 and the brush holder 20 with brushes 21 and 22. The slip ring arrangement 50 comprises two sleeve-shaped slip rings 51 and 52 which, in a manner lying axially next to one another, are seated fixedly on the rotor shaft 121 so as to rotate with it, and busbars 53 and 54 and contact tabs 55 and 56. The first slip ring 51 which is arranged closer to the rotor winding is connected via the busbar 53 and the contact tab 55 to an end 57 of the winding wire of the rotor winding. Here, one end of the busbar 53 makes contact with the winding wire end 57, whereas the other end of the busbar 53 is connected to the contact tab 55, the opposite end of which is connected to the slip ring 51. In a corresponding way, the second slip ring 52 which is arranged axially further away from the rotor winding is connected via the busbar 54 and the contact tab 56 to the second winding wire end 58 of the rotor winding. The brushes 21 and 22 which are guided in the housing-side brush holder 20 lie in contact on the slip rings 51 and 52.

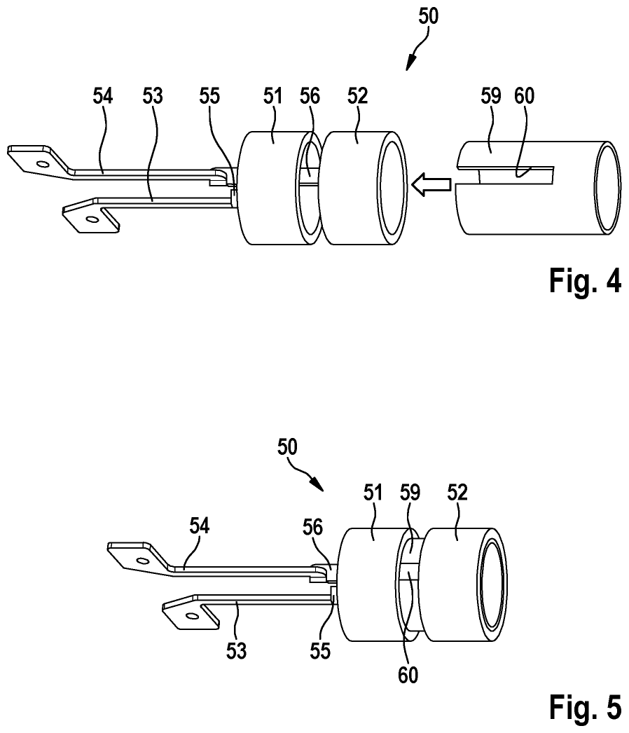

As shown in FIG. 2 in conjunction with FIGS. 3 to 5, the slip ring arrangement 50 comprises, moreover, an insulating sleeve 59 which consists of an electrically insulating material, but has a high thermal conductivity. For example, a polymer material or a ceramic material comes into question as a material for the insulating sleeve 59. The insulating sleeve 59 is pushed directly onto the rotor shaft 121 and is connected fixedly to the rotor shaft 121 so as to rotate with it, and is in direct contact with the circumferential face of the rotor shaft 121. The two slip rings 51 and 52 which are spaced apart axially from one another are both seated directly on the outer side of the insulating sleeve 59 and are connected fixedly to the insulating sleeve so as to rotate with it. The insulating sleeve 59 has only a comparatively small wall thickness of, for example, at most 0.5 mm or 1 mm and a thermal conductivity of at least 2 W/mK, a significantly higher thermal conductivity possibly also being possible, for example a thermal conductivity of at least 50 W/mK, at least 100 W/mK, at least 170 W/mK or even higher. Said high thermal conductivity makes an efficient thermal dissipation of the heat which is produced in the slip ring arrangement 50 via the rotor shaft 121 possible. That shaft section of the rotor shaft 121 which is a carrier of the slip ring arrangement 50 with the insulating sleeve 59 can have a comparatively great external diameter on account of the thin-walled embodiment of the insulating sleeve 59, without the overall diameter of the rotor shaft 121 and the slip ring arrangement 50 increasing in comparison with embodiments from the prior art.

A slot 60 which extends in the axial longitudinal direction is made in the insulating sleeve 59, which slot 60 extends axially only over a part length of the insulating sleeve 59 and is configured so as to be open on the edge side toward an end side of the insulating sleeve. The slot 60 in the insulating sleeve 59 allows the contact tab 56 which is assigned to the slip ring 52 to be guided through the interior space of the two slip rings 51, 52 and, in the case of a pushed-in insulating sleeve 59, to be guided radially through the slot 60, in order to establish the contact with the slip ring 52.

The further slip ring 51 is also contacted on its inner side by the associated contact tab 55.

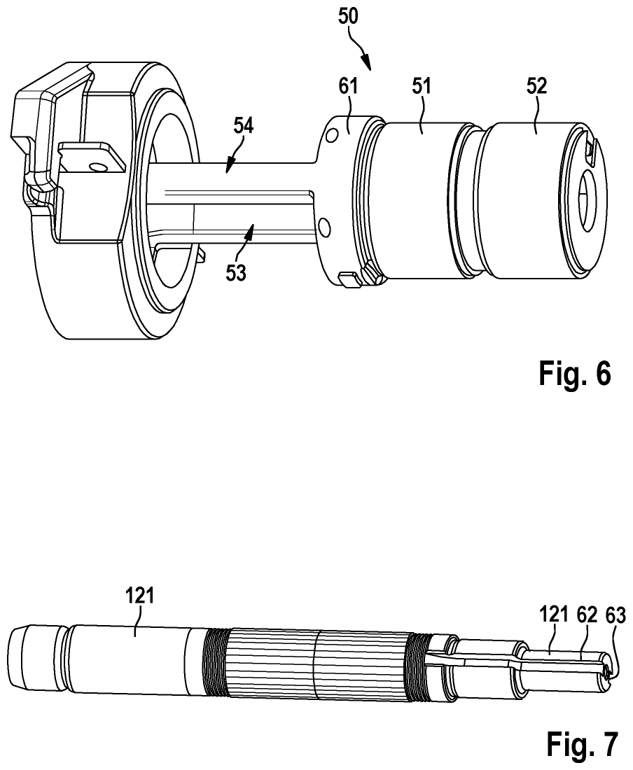

As can be gathered from FIG. 6, the slip ring arrangement 50 has, moreover, a plastic overmolding 61, with which, in particular, the busbars 53 and 54 are overmolded. In the assembled state, the busbars 53 and 54 lie in longitudinal grooves 62 and 63 (FIG. 2, FIG. 7) which are made on opposite sides in that section of the rotor shaft 121 which is the carrier of the slip ring arrangement 50. The longitudinal grooves 62 and 63 extend beyond that section of the rotor shaft 121 which carries the slip ring arrangement 50, and extend as far as the winding wire ends of the rotor winding. The busbars 53 and 54 including the plastic overmolding 61 can possibly be received in the longitudinal grooves 62 and 63 completely in the radial direction, or can protrude radially beyond the longitudinal grooves 62 and 63.

The plastic overmolding 61 of the busbars 53 and 54 ensures the electric insulation of the busbars from the rotor shaft 121.

1. A rotor of an electric machine, in particular of a claw pole machine, having a slip ring arrangement with two slip rings, each of the slip rings being arranged on a rotor shaft of the rotor and connected via a respective busbar to a winding wire of a rotor winding, the slip rings being placed onto an insulating sleeve that is (a) made from an insulating sleeve material, (b) of electrically insulating configuration, and (c) seated directly on the rotor shaft, the insulating sleeve having a thermal conductivity of at least 2 W/mK.

2. The rotor as claimed in claim 1, the insulating sleeve material comprising a polymer.

3. The rotor as claimed in claim 2, the insulating sleeve material comprising a material mixture of polymer and a filler.

4. The rotor as claimed in claim 1, the insulating sleeve material comprising a ceramic and having a thermal conductivity of at least 170 W/mK.

5. The rotor as claimed in claim 4, the insulating sleeve material comprising a ceramic fiber composite material.

6. The rotor as claimed in claim 1, further comprising two contact tabs, each of the contact tabs being connected to a respective one of the slip rings and lying between the respective one of the slip rings and a corresponding one of the busbars.

7. The rotor as claimed in claim 6, one of the contact tabs protruding into a slot in a wall of the insulating sleeve.

8. The rotor as claimed in claim 7, the wall having a wall thickness of at most 1 mm or of at most 2 mm or of from 1.5 mm to 2.5 mm.

9. The rotor as claimed in claim 8, the rotor shaft having a shaft section configured to receive the slip rings, the shaft section forming at least one longitudinal groove extending in a longitudinal direction for receiving electric contacts of the slip rings.

10. The rotor as claimed in claim 9, the shaft section forming two longitudinal grooves spaced apart from one another, each of the longitudinal grooves being configured to receive an electric contact of a respective one of the slip rings.

11. The rotor as claimed in claim 9, further comprising, in each of the at least one longitudinal groove, plastic material overmolded at least partially on at least one of a corresponding busbar and a corresponding contact tab.

12. An electric machine, in particular a claw pole machine, having a rotor as claimed in claim 1.
